(19) United States
(12) Patent Application Publication
(10) Pub. No.: US 2006/0293214 A1
(43) Pub. Date: Dec. 28, 2006

(54) Synergistic acidic ternary biocidal compositions

(76) Inventors: Lily Cheng, Oakland, CA (US); Richard E. Simon, Oakland, CA (US); Benjamin D. Tanner, Oakland, CA (US); David L. DeLeeuw, Oakland, CA (US)

Correspondence Address: THE CLOROX COMPANY, P.O. BOX 24305, OAKLAND, CA, 94623-1305, US

(21) Appl. No.: 11/168,096

(22) Filed: Jun. 28, 2005

(51) Int. Cl. C11D 3/00

(52) U.S. Cl. 510/504

(57) ABSTRACT

Aqueous dilutions of acidic ternary compositions having unusually synergistic antimicrobial activity against Staphylococcus aureus and Salmonella choleraesuis microorganisms are disclosed. The compositions encompass ternary component mixtures of an alpha-hydroxycarboxylic acid, a monohydric water soluble alkanol and an anionic tenside having a Ternary Ratio residing within a defined phase region wherein synergistic antimicrobial activity is observed; whereas mixtures outside of the defined phase region and those lacking any one of the components do not exhibit synergistic activity. Compositions, methods and articles employing the inventive ternary synergistic compositions, and their utility in sanitizing and disinfecting hard surfaces are described.

### FIELD OF THE INVENTION

The present invention is directed to aqueous dilutions of synergistic acidic ternary compositions having excellent antimicrobial activity against Staphylococcus aureus and Salmonella choleraesuis microorganisms. Most particularly, the present invention is directed to ternary component mixtures of an alpha-hydroxycarboxylic acid, a monohydric water soluble alkanol and an anionic tenside having a Ternary Ratio residing within a phase region defined by compositional extrema wherein synergistic antimicrobial efficacy is observed. The present invention is further directed to the use of these synergistic ternary compositions, methods and articles employing them and their aqueous diluted forms for use in sanitizing and/or disinfecting hard surfaces.

### BACKGROUND OF THE INVENTION

It is desirable to employ effective but safe and non-toxic compositions that can effect both cleaning and disinfection of hard surfaces, including areas in and around the home that may be contacted by humans, pets and children, such as floors, bathroom and kitchen surfaces, the latter generally host to articles and areas that may come into contact with food intended for ingestion, i.e. “food contact surfaces.” Even more desirable are compositions which are effective at relatively low active levels such that following their use, rinsing of the treated surface is not necessitated owing to any remaining residue contributed by the treatment itself. Although skin and/or food safe and/or ingestible materials may be employed such that any treatment residue remaining is not of concern regarding subsequent contact, transfer to food, and/or ingestion, it is most desirable to effect cleaning and microbial reduction in a manner by which any compositional residue remaining is minimized to the greatest possible extent. This is particularly challenging since many safe or low toxicity materials employed in the art generally require a certain level for cleaning that necessitates rinsing afterwards to remove unsightly residues that would otherwise remain behind on treated surfaces. It is particularly challenging to both clean and disinfect a surface, as even greater levels are required for disinfection, which requires a complete kill rather than a significant reduction in the number of microorganisms remaining.

While many effective antimicrobial products exist in the market, few are adaptable for use on multiple surfaces, particularly food contact surfaces. Of those that are, acidic based systems are generally preferred, and tend to employ either strong acids, such as the mineral acids (hydrochloric, phosphoric, organophosphonic, sulfuric, etc.) or weaker organic acids. Weak organic acids are desirable, such as lactic acid and citric acid, and are recognized by the United States Environmental Protection Agency (US EPA) as antimicrobial actives. Being weak acids by definition, they are generally safer to use than mineral acids due to less aggressive tendencies to irritate or attack surfaces to which they are applied. A shortcoming, however, is that the organic acids generally have weaker antimicrobial properties when used by themselves at low levels in aqueous solutions, thus requiring higher levels that contribute to unsightly residues, or if used at lower levels require fairly long contact times in excess of 10 minutes to effect disinfection of treated surfaces. These are clearly impractical in consideration of typical consumer use behaviors with regard to cleaning. Other approaches that have been employed include using fairly low levels of these organic acids for cleaning, which owing to low residues avoids the need for a second rinsing step. Nevertheless, this approach at best provides only partial microbial reduction or sanitization of the surface, rather than complete disinfection, in addition to long contact times.

Thus, what is needed are safe and non-toxic compositions that can effect both cleaning and either sanitization and/or disinfection of hard surfaces, including surfaces in and around the home that may be contacted by humans, pets and children, such as floors, bathroom and kitchen surfaces that are effective with short exposure times, and do not require rinsing after application.

### SUMMARY OF THE INVENTION

The present invention relates generally to aqueous dilutions of synergistic acidic ternary compositions having excellent antimicrobial activity against Staphylococcus aureus and Salmonella choleraesuis microorganisms. Most particularly, the present invention relates to ternary component mixtures of an alpha-hydroxycarboxylic acid, a monohydric water soluble alkanol and an anionic tenside having a Ternary Ratio residing within a ternary phase region defined by compositional extrema wherein surprising synergistic antimicrobial efficacy is observed. The present invention further relates to the use of these synergistic ternary compositions, methods and articles employing them and their aqueous diluted forms for use in sanitizing and/or disinfecting hard surfaces.

One aspect of the present invention is a composition comprising: (A) a ternary mixture comprising: (i) an alpha-hydroxycarboxylic acid; (ii) a monohydric water soluble alkanol; and (iii) an anionic tenside; wherein said ternary mixture is within a phase region bordered by extrema comprising a Ternary Ratio of (i):(ii):(iii) being 0.37:0.58:0.05, 0.05:0.58:0.37, 0.61:0.34:0.05 and 0.05:0.34:0.61; and (B) an aqueous diluent; wherein said composition has a pH less than 7; and wherein said composition provides at least a 3-log reduction of either Staphylococcus aureus or Salmonella choleraesuis. Another aspect of the present invention are compositions that provide a 6-log reduction on both Staphylococcus aureus and Salmonella choleraesuis. Yet another aspect of the present invention are compositions that are free of quaternary ammonium biocides.

A further aspect of the present invention is a method for disinfecting a hard surface comprising contacting said hard surface by direct application of a composition comprising: (A) a ternary mixture comprising: (i) from about 0.5 to 3.0% of an alpha-hydroxycarboxylic acid; (ii) from about 0.5 to 5.0% of a monohydric water soluble alkanol; and (iii) from 0.1 to 3.0% of an anionic tenside; wherein said ternary mixture is within a phase region bordered by extrema comprising a Ternary Ratio of (i):(ii):(iii) being 0.37:0.58:0.05, 0.05:0.58:0.37, 0.61:0.34:0.05 and 0.05:0.34:0.61; (B) an aqueous diluent; (C) optionally, an adjunct selected from the group consisting of dyes, essential oils, buffers, builders, preservatives, cleaning agents, thickeners, and mixtures thereof; wherein said composition has a pH less than 7; and wherein said composition provides at least a 3-log reduction of either Staphylococcus aureus or Salmonella choleraesuis.

Another aspect of the present invention are compositions for use on food contact surfaces, wherein the synergistic ternary acidic compositions and any optional adjuncts are selected from only GRAS and/or food grade ingredients.

Yet a further aspect of the present invention is a premoistened wipe comprising an absorbent substrate impregnated with an effective amount of a composition comprising: (A) a ternary mixture comprising: (i) from about 0.5 to 3.0 % of an alpha-hydroxycarboxylic acid; (ii) from about 0.5 to 5.0% of a monohydric water soluble alkanol; and (iii) from 0.1 to 3.0% of an anionic tenside; wherein said ternary mixture is within a phase region bordered by extrema comprising a Ternary Ratio of (i):(ii):(iii) being 0.37:0.58:0.05, 0.05:0.58:0.37, 0.61:0.34:0.05 and 0.05:0.34:0.61; (B) an aqueous diluent; (C) optionally, an adjunct selected from the group consisting of dyes, essential oils, buffers, builders, preservatives, cleaning agents, thickeners, and mixtures thereof; wherein said composition has a pH less than 7; and wherein said effective amount of said composition provides at least a 3-log reduction of either Staphylococcus aureus or Salmonella choleraesuis.

Further features and advantages of the present invention will become apparent to those of ordinary skill in the art in view of the detailed description of preferred embodiments below, when considered together with the attached drawings and claims.

### BRIEF DESCRIPTION OF THE DRAWINGS

The foregoing aspects and others will be readily appreciated by the skilled artisan from the following description of illustrative embodiments when read in conjunction with the accompanying drawings.

FIG. 1 is a ternary phase diagram showing the antimicrobial synergistic phase space encompassing compositions of the present invention that comprise ternary mixtures of an alpha-hydroxycarboxylic acid, a monohydric water soluble alkanol, and an anionic tenside. Points are indicated representing the four compositional extrema (defined in terms of a Ternary Ratio) corresponding to the borders of the compositional space, indicated by the shaded region, wherein synergistic antimicrobial combinations of the ternary components of the present invention have been discovered. The three components are represented in the ternary phase diagram such that each individual component (100 weight percent active or alternatively expressed as the weight fraction equivalent of 1.0) corresponds to one of the apexes of the triangle as shown in FIG. 1.

These and other objects and advantages of the present invention will become more fully apparent from the following description taken in conjunction with the accompanying drawing(s).

### DETAILED DESCRIPTION

Before describing the present invention in detail, it is to be understood that this invention is not limited to particularly exemplified systems or process parameters that may, of course, vary. It is also to be understood that the terminology used herein is for the purpose of describing particular embodiments of the invention only, and is not intended to limit the scope of the invention in any manner.

All publications, patents and patent applications cited herein, whether supra or infra, are hereby incorporated by reference in their entirety to the same extent as if each individual publication, patent or patent application was specifically and individually indicated to be incorporated by reference.

It must be noted that, as used in this specification and the appended claims, the singular forms “a,” “an” and “the” include plural referents unless the content clearly dictates otherwise. Thus, for example, reference to a “surfactant” includes two or more such surfactants.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

In the application, effective amounts are generally those amounts listed as the ranges or levels of ingredients in the descriptions, which follow hereto. Unless otherwise stated, amounts listed in percentage (“%'s”) are in weight percent (based on 100% active) of the total composition.

As used herein, the term “sanitizer” or “sanitization” is intended to include any composition or method that provides at least a 3-log (10³ ) reduction of a microbial species within a specified time interval following application to a microbial population.

As used herein, the term “disinfect” or “disinfection” is intended to include any composition or method that provides at least a 6-log (10⁶) reduction of a microbial species within a specified time interval following application to a microbial population.

The term “cleaning composition”, as used herein, is meant to mean and include a cleaning formulation having at least one surfactant.

The terms “tenside” and “surfactant”, as used herein, is meant to mean and include a substance or compound that reduces surface tension when dissolved in water or an aqueous solution, or that reduces interfacial tension between two liquids, or between a liquid and a solid. Unless otherwise indicated, the terms “tenside” and “surfactant” includes substances or compounds that are anionic, cationic, nonionic, zwitterionic and/or amphoteric in nature.

The term “hard surface”, as used herein, is meant to mean and include any generally solid or non-porous surface found in and around a home or business environment, including for example but not limited to those surfaces comprising floors, walls, fixtures, appliances, countertops and materials of construction of such surfaces including for example but not limited to painted surfaces, metal, ceramic, tile, stone, glass, vinyl, glazed porcelain, plastics, laminates, and the like. In addition, food contact surfaces, such as countertops, food preparation areas, cutting boards and the like are also included, as well as the materials of construction of said surfaces. articles and fixtures.

Composition

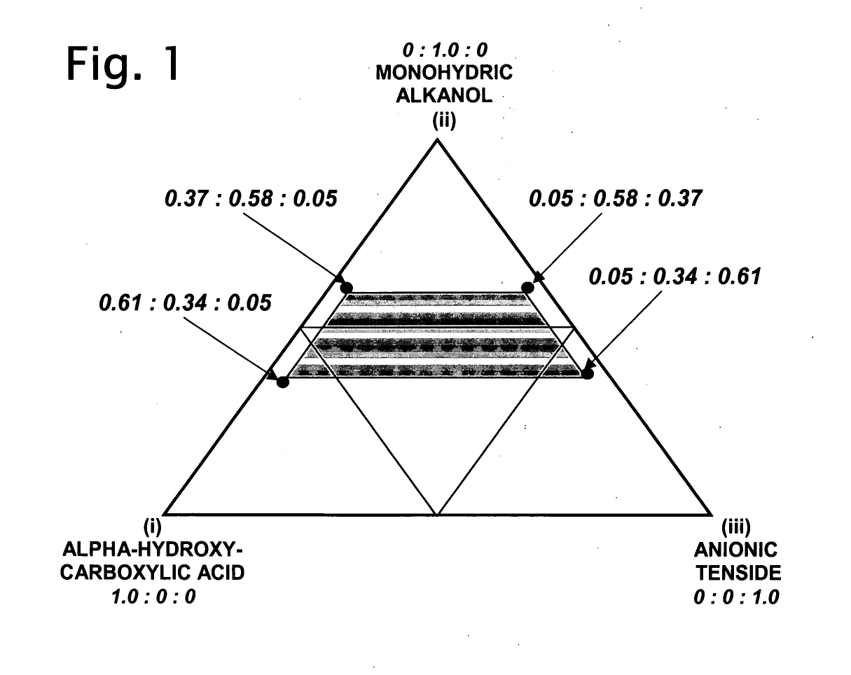

The inventive compositions, methods and premoistened wipes described herein employ antimicrobial synergistic combinations of an alpha-hydroxycarboxylic acid, a monohydric water soluble alkanol, and an anionic tenside that provide significantly enhanced reduction of Staphylococcus aureus and Salmonella choleraesuis microorganisms. Inventive compositions exhibiting the surprising synergistic microbial efficacy have a Ternary Ratio of the ternary components that is found to lie within a particular phase region that is best represented by referring to a ternary phase diagram of the three components of the compositions as shown in FIG. 1. The phase region wherein the inventive compositions are found that exhibit synergistic microbial efficacy is best described in terms of the extrema, that is to say the compositional points defining the outer borders of the phase region expressed in terms of the ternary compositional components as a Ternary Ratio, irrespective of the aqueous diluent and other optional adjuncts present. The extrema are thus, with respect to the weight % of the active components, expressed as the normalized weight fraction of each of the three essential active components with respect to their combined weights on a 100% active weight basis.

Thus, the Ternary Ratio can be defined, in terms of the three components (i) alpha-hydroxycarboxylic acid, (ii) monohydric water soluble alkanol and (iii) anionic tenside, as the normalized ratio expressed as in Equation I as follows:

$$Ternary Ratio = \frac{{W}_{f} ( n )}{{Σ [ {W}_{f} ( n ) ]}_{n = 1 , 2 , 3}} = \frac{{W}_{f} ( i ) \text{:} {W}_{f} ( ii ) \text{:} {W}_{f} ( iii )}{[ {W}_{f} ( i ) + {W}_{f} ( ii ) + {W}_{f} ( iii ) ]} \qquad ( I )$$

wherein W_{f} (n) is the contributing weight fraction of component n (on a 100 wt % active basis for n=i, ii and iii, respectively) in the ternary composition, normalized by the sum of the total weight fraction contributions of all three component types (i, ii and iii) and/or the sum of all equivalent species of the three ternary component types, irrespective of the aqueous diluent and other optional adjuncts present which are not factored into the ratio determination. Thus, for example, in embodiments wherein two suitable monohydric water soluble alkanols as disclosed herein are included in the inventive composition, the total weight contribution of the two monohydric water soluble alkanols are included in the calculation of component (ii) contribution as well as the contribution to the total ternary component weight (denominator of Equation I); and likewise for any other species of component types that are mixed or combined, such as for example a mixture of two or more anionic tensides according to the present invention. However, optional adjuncts, for example a secondary solvent that is not a selected monohydric water soluble alkanol according to the present invention, or for example an auxiliary nonionic surfactant, are not included as contributing to the weight fraction of any of the ternary components, nor as contributing to the total ternary composition in the calculation of the Ternary Ratio parameter.

The inventive compositions discovered herein comprise diluted aqueous compositions of those ternary component compositions encompassed within the phase region defined by extrema having ratios of (i) alpha-hydroxycarboxylic acid: (ii) monohydric water soluble alkanol: (iii) anionic tenside corresponding to the border of the observed phase region of which the extrema, expressed as a Ternary Ratio as defined hereinabove are found accordingly to be 0.37:0.58:0.05, 0.05:0.58:0.37, 0.61:0.34:0.05 and 0.05:0.34:0.61, which correspond to the bordering compositions enclosing the synergistic ternary region bound by the extrema as indicated in the shaded region of FIG. 1.

Alpha-Hydroxycarboxylic Acid

The inventive composition comprises at least one alpha-hydroxycarboxylic acid, which contributes to the exhibited synergistic biocidal effect of the ternary compositions of the present invention described herein.

Suitable in the present invention are alpha-hydroxycarboxylic acids selected from alkyl alpha-hydroxyacids, aralkyl and aryl alpha-hydroxyacids, polyhydroxy alpha-hydroxyacids, polycarboxylic alpha-hydroxyacids, alpha-hydroxyacid related compounds, alpha-ketoacids and related compounds, and other related compounds including their lactone forms, which include the following:

(1) Alkyl Alpha-Hydroxyacids

Suitable alkyl alpha-hydroxyacids for use in the present invention include 2-hydroxyethanoic acid (glycolic acid), 2-hydroxypropanoic acid (lactic acid), 2-methyl 2-hydroxypropanoic acid (methyllactic acid), 2-hydroxybutanoic acid, 2-hydroxypentanoic acid, 2-hydroxyhexanoic acid, 2-hydroxyheptanoic acid, 2-hydroxyoctanoic acid, 2-hydroxynonanoic acid, 2-hydroxydecanoic acid, 2-hydroxyundecanoic acid, 2-hydroxydodecanoic acid (alpha-hydroxylauric acid), 2-hydroxytetradecanoic acid (alpha-hydroxymyristic acid), 2-hydroxyhexadecanoic acid (alpha-hydroxypalmitic acid), 2-hydroxyoctadecanoic acid (alpha-hydroxystearic acid) and 2-hydroxyeicosanoic acid (alpha-hydroxyarachidonic acid).

(2) Aralkyl and Aryl Alpha-Hydroxyacids

Suitable aralkyl and aryl alpha-hydroxyacids for use in the present invention include 2-phenyl 2-hydroxyethanoic acid (mandelic acid), 2,2-diphenyl 2-hydroxyethanoic acid (benzilic acid), 3-phenyl 2-hydroxypropanoic acid (phenyllactic acid), 2-phenyl 2-methyl 2-hydroxyethanoic acid (atrolactic acid), 2-(4′-hydroxyphenyl) 2-hydroxyethanoic acid, 2-(4′-clorophenyl) 2-hydroxyethanoic acid, 2-(3′-hydroxy-4′-methoxyphenyl) 2-hydroxyethanoic acid, 2-(4′-hydroxy-3′-methoxyphenyl) 2-hydroxyethanoic acid, 3-(2′-hydroxyphenyl) 2- hydroxypropanoic acid, 3-(4′-hydroxyphenyl) 2-hydroxypropanoic acid and 2-(3′,4′-dihydroxyphenyl)2-hydroxyethanoic acid.

(3) Polyhydroxy Alpha-Hydroxyacids

Suitable polyhydroxy alpha-hydroxyacids for use in the present invention include 2,3-dihydroxypropanoic acid (glyceric acid), 2,3,4-trihydroxybutanoic acid (isomers; erythronic acid, threonic acid), 2,3,4,5-tetrahydroxypentanoic acid (isomers; ribonic acid, arabinoic acid, xylonic acid, lyxonic acid), 2,3,4,5,6-pentahydroxyhexanoic acid (isomers; aldonic acid, altronic acid, gluconic acid, mannoic acid, gulonic acid, idonic acid, galactonic acid, talonic acid) and 2,3,4,5,6,7-hexahydroxyheptanoic acid (isomers; glucoheptonic acid, galactoheptonic acid, etc.).

(4) Polycarboxylic Alpha Hydroxyacids

Suitable polycarboxylic alpha-hydroxyacids for use in the present invention include 2-hydroxypropane-1,3-dioic acid (tartronic acid), 2-hydroxybutane-1,4-dioic acid (malic acid), 2,3-dihydroxybutane-1,4-dioic acid (tartaric acid), 2-hydroxy-2-carboxypentane-1,5-dioic acid (citric acid) and 2,3,4,5-tetrahydroxyhexane-1,6-dioic acid (isomers; saccharic acid, mucic acid, etc.)

(5) Alpha-Hydroxyacid Related Compounds

Suitable alpha-hydroxyacid related compounds suitable for use in the present invention include ascorbic acid, quinic acid, isocitric acid, tropic acid, 3-chlorolactic acid, trethocanic acid, cerebronic acid, citramalic acid, agaricic acid and 2-hydroxynervonic acid and aleuritic acid.

(6) Alpha-Ketoacids and Related Compounds

Suitable alpha-ketoacids and related compounds suitable for use in the present invention include 2-ketoethanoic acid (glyoxylic acid), methyl 2-ketoethanoate, 2-ketopropanoic acid (pyruvic acid), methyl 2-ketopropanoate (methyl pyruvate), ethyl 2-ketopropanoate (ethyl pyruvate), propyl 2-ketopropanoate (propyl pyruvate), 2-phenyl-2-ketoethanoic acid (benzoylformic acid), methyl 2-phenyl-2-ketoethanoate (methyl benzoylformate), ethyl 2-phenyl-2-ketoethanoate (ethyl benzoylformate), 3-phenyl-2-ketopropanoic acid (phenylpyruvic acid), methyl 3-phenyl-2-ketopropanoate (ethyl phenylpyruvate), 2-ketobutanoic acid, 2-ketopentanoic acid, 2-ketohexanoic acid, 2-ketoheptanoic acid, 2-ketooctanoic acid, 2-ketododecanoic acid and methyl 2-ketooctanoate.

Also suitable are the dimeric and polymeric forms of alpha-hydroxyacids and the related compounds which may be incorporated into the compositions of the present invention including, but are not limited to, acyclic esters and cyclic esters such as glycolyl glycollate, ethyl lactate, lactyl lactate, glycolide, lactide, polyglycolic acid and polylactic acid.

The alpha-hydroxycarboxylic acid is generally present at a level of between 0.5 to-5.0 wt % of the total composition following combination with an aqueous diluent.

In one embodiment of the present invention are ternary compositions in which the alpha-hydroxyacid is selected from the group consisting of citric acid, lactic acid, glycolic acid, mandelic acid, malic acid, and/or combinations thereof. In another embodiment of the present invention, the ternary compositions employ lactic acid as the alpha-hydroxyacid.

Monohydric Water Soluble Alkanol

The inventive composition comprises at least one monohydric water soluble alkanol which contributes to the exhibited synergistic biocidal effect of the ternary compositions of the present invention described herein. The at least one monohydric alkanol is preferably water soluble, that is to say, fully miscible with water over the full dilution range of between 0 to 100% by volume with respect to the monohydric alkanol with water, and hence remaining as a single continuous phase in aqueous solution with water irrespective of dilution ratio or compositional variation. Without being bound by theory, it is believed that the unique synergistic antimicrobial properties discovered as described herein with respect to the ternary mixtures of the present invention, relate to the property of the diluted aqueous compositions employing the said ternary component mixtures to maintain a single continuous liquid phase while present on treated surfaces during which evaporation of the volatile components occurs, which is mostly water being present in the greater proportion as the aqueous diluent, and to a lesser extent the volatile monohydric alkanol. Thus, it is believed that the surprising synergistic efficacy exhibited by the ternary compositions according to the present invention are due in part to their aqueous dilutions remaining phase stable, and thereby subjecting the microorganisms against which they are directed, to a stable liquid phase which remains continuous, i.e. exhibits no component precipitation or liquid phase separation owing to disproportionation, over the span of time (contact time) necessary to achieve disinfectant action even as the volatile components evaporate after application of the aqueous treatment compositions to the microbial contaminated surfaces according to the methods of the present invention. The presence of the monohydric water soluble alkanol is believed to help maintain the ternary compositions as a single continuous phase over the dilution range corresponding to gradual evaporation and loss of volatile component(s), thus maintaining a microbially effective composition even after long contact times of up to 10 minutes required to completely kill (disinfect) microorganisms on surfaces under the highest challenge conditions of soil load and high microbial colony population according to the antimicrobial efficacy test protocols described further hereinbelow. The inventive compositions may further include less water soluble solvent materials as optional adjuncts, but only to the extent that the choice of optional solvent and addition level does not negatively interfere with the synergistic antimicrobial properties exhibited by the ternary compositions of the present invention.

Suitable monohydric water soluble alkanols include, but are not limited to, methanol, ethanol, n-propanol and isopropanol and the like.

Additional alkanols suitable for use herein include monohydric alkylene glycols and alkylene glycol ethers. Suitable alkylene glycol ethers include, but are not limited to, ethylene glycol monopropyl ether, ethylene glycol monobutyl ether, ethylene glycol monohexyl ether, diethylene glycol monopropyl ether, diethylene glycol monobutyl ether, diethylene glycol monohexyl ether, propylene glycol methyl ether, propylene glycol ethyl ether, propylene glycol mono-n-propyl ether, propylene glycol mono-iso-propyl ether, propylene glycol monobutylether, dipropylene glycol monomethylether, and/or combinations thereof. Commercially, these may be selected from the Dowanol “E” and Dowanol “P” series of glycol ether solvents which are available from the Dow Chemical Company, Midland, Mich. as well as other suppliers under different tradenames. The most preferred alkylene glycol ethers are fully water soluble (miscible) at any relative concentration with respect to the aqueous diluent are preferred. However, also suitable are alkylene glycol ethers that are not generally fully miscible with water, but are at least partially water soluble. These may suitably be employed provided that they are used at levels with respect to the aqueous diluent such that the level of the alkylene glycol ether present in the final usage formulation is fully soluble with water at either the usage temperature or at 25° C.

The monohydric water soluble alkanol is generally present at a level of between 0.5 to 5.0 wt % of the total composition following combination with an aqueous diluent. In embodiments of the present invention in which compositions are desired that conform to limits imposed to reduce volatile organic carbon (VOC) content, the preferred level of the alkanol is between 0.5 to 5.0 wt %, and more preferably below 4.0 wt %.

For food contact surface usage, the water soluble alkanols having high evaporation rates and/or which are generally recognized as safe (GRAS) are most suitable. In one embodiment of the present invention for food contact surface usage, ethanol is a particularly preferred monohydric water soluble alkanol.

In another embodiment of the present invention for cleaning and antimicrobial treatment of a hard surface, the water soluble alkanol comprises a glycol ether selected from ethylene glycol monopropyl ether, ethylene glycol monobutyl ether, ethylene glycol monohexyl ether, diethylene glycol monopropyl ether, diethylene glycol monobutyl ether, diethylene glycol monohexyl ether, propylene glycol methyl ether, propylene glycol ethyl ether, propylene glycol n-propyl ether, propylene glycol monobutyl ether, propylene glycol t-butyl ether, and/or combinations thereof.

Anionic Tenside

The inventive composition comprises at least one anionic tenside which contributes to the exhibited synergistic biocidal effect of the ternary compositions of the present invention described herein. The anionic tenside may include anionic hydrotropes, surfactants, wetting agents and the like. Advantageously, the anionic tenside also provides some utility in reducing the surface tension of the compositions and/or improving the wetting efficiency of the treated surface to promote spreading of the applied compositions of the present invention.

Suitable anionic tensides include anionic surfactants, which may comprise a sulfonate or a sulfate surfactant. Suitable anionic surfactants include, for example, but are not limited to alkyl sulfates, linear or branched alkyl benzene sulfonates, and alkyldiphenyloxide disulfonates. Other suitable anionic surfactants include the isethionates such as the acyl isethionates, N-acyl taurates, fatty acid amides of methyl tauride, alkyl succinates and sulfosuccinates, monoesters of sulfosuccinate (for instance, saturated and unsaturated C₁₂-C₁₈ monoesters) diesters of sulfosuccinate (for instance saturated and unsaturated C₆-C₁₄ diesters), N-acyl sarcosinates. Resin acids and hydrogenated resin acids are also suitable, such as rosin, hydrogenated rosin, and resin acids and hydrogenated resin acids present in or derived from tallow oil. Anionic sulfate surfactants suitable for use herein include the linear and branched primary and secondary alkyl sulfates, alkyl ethoxysulfates, fatty oleoyl glycerol sulfates, alkyl phenol ethylene oxide ether sulfates, the C₅-C₁₇ acyl-N-(C₁-C₄ alkyl) and -N-(C₁-C₂ hydroxyalkyl) glucamine sulfates, and sulfates of alkylpolysacchanides such as the sulfates of alkylpolyglucoside (the nonionic non-sulfated compounds being described herein). Alkyl sulfate surfactants may be selected from the linear and branched primary C₁₀-C₁₈ alkyl sulfates, the C₁₁-C₁₅ branched chain alkyl sulfates, or the C₁₂-C₁₄ linear chain alkyl sulfates.

Anionic sulfonate surfactants suitable for use herein include the salts of C₅-C₂₀ linear alkylbenzene sulfonates, alkyl ester sulfonates, C₆-C₂₂ primary or secondary alkane sulfonates, C₆-C₂₄ olefin sulfonates, sulfonated polycarboxylic acids, alkyl glycerol sulfonates, fatty acyl glycerol sulfonates, fatty oleyl glycerol sulfonates, and any mixtures thereof. Suitable anionic carboxylate surfactants include the alkyl ethoxy carboxylates, the alkyl polyethoxy polycarboxylate surfactants and the soaps (‘alkyl carboxyls’), especially certain secondary soaps as described herein. Suitable alkyl ethoxy carboxylates include those with the formula RO—(CH₂CH₂0)ₓ-CH₂COO⁻M⁺ wherein R is a C₆ to C₁₈ alkyl group, x ranges from 0 to 10, and the ethoxylate distribution is such that, on a weight basis, the amount of material where x is 0 is less than 20% and M⁺ is any suitable cation. Suitable alkyl polyethoxypoly-carboxylate surfactants include those having the formula RO—(CHR¹—CHR²-0)ₓ-R³ wherein R is a C₆ to C₁₈ alkyl group, x is from 1 to 25, R¹ and R² are selected from the group consisting of hydrogen, methyl acid radical, succinic acid radical, hydroxysuccinic acid radical, and mixtures thereof, and R³ is selected from the group consisting of hydrogen, substituted or unsubstituted hydrocarbon having between 1 and 8 carbon atoms, and mixtures thereof.

Suitable soap surfactants include the secondary soap surfactants, which contain a carboxyl unit connected to a secondary carbon. Suitable secondary soap surfactants for use herein are water-soluble members selected from the group consisting of the water-soluble salts of 2-methyl-1-undecanoic acid, 2-ethyl-1-decanoic acid, 2-propyl-1-nonanoic acid, 2-butyl-1-octanoic acid and 2-pentyl-1-heptanoic acid.

Other suitable anionic surfactants are the alkali metal sarcosinates of formula R—CON(R¹CH)COO⁻M⁺, wherein R is a C₅-C₁₇ linear or branched alkyl or alkenyl group, R¹is a C₁-C₄ alkyl group and M⁺ is an alkali metal ion. Examples are the myristyl and oleoyl methyl sarcosinates in the form of their sodium salts.

The anionic tenside is generally present at a level of between 0.5 to 5.0 wt % of the total composition following combination with an aqueous diluent.

In one embodiment of the present invention, the anionic tenside is selected from an alkyl phosphates, alkyl phosphonates, alkyl sulfates, alkyl sulfonates, aryl sulfonates, alkyl aryl sulfonates, alkyl disulfonates, alkyldiphenyloxide disulfonate and/or combinations thereof.

In another embodiment of the present invention, the anionic tenside comprises an alkyl sulfate having between 8 to 18 carbon atoms.

In yet another embodiment of the present invention, the anionic tenside comprises an alkyldiphenyloxide disulfonate with an alkyl group having between 6 to 12 carbon atoms.

In further embodiments of the present invention wherein low foaming properties upon application to a surface are desirable, the anionic tenside is present at a level of between 0.5 to about 3.0 wt %, and in preferred embodiments with particularly low foaming properties, the anionic tenside is present at levels below about 2.0 wt %.

In yet another embodiment of the present invention particularly suited for use on food contact surfaces, the anionic tenside is preferably selected from the group of materials previously approved or found in food contact cleaning solutions, including, but not limited to sodium lauryl sulfate (“SLS” CAS Reg. No. 000151-21-3), sodium n-alkyl benzene sulfonate (CAS Reg. No. 008046-53-5), sodium decylbenzene sulfonate (“SDS” CAS Reg. No. 001322-98-1), sodium dodecylbenzene sulfonate (CAS Reg. No. 025155-30-0), the sucrose fatty acid esters (CAS Reg. No. 977019-37-6), dodecyl diphenyloxide disulfonate (CAS Reg. No. 30260-73-2), commercially available from Dow Chemical as Dowfax 2A1, disodium N-decyldiphenyl ether disulfonate (“C12DADS” CAS Reg. No. 36445-71-3), lignin sodium sulfonate (CAS Reg. No. 008061-51-6), 1-octanesulfonic-2-sulfinic acid (CAS Reg. No. 113652-56-5), 1,2-octanedisulfonic acid (CAS Reg. No. 113669-58-2), sodium 1-octanesulfonate (CAS Reg. No. 5324-84-5), sodium 2-ethylhexyl sulfate (CAS Reg. No. 000126-92-1), butyl oleate sulfate (CAS Reg. No. 038621-44-2), sulfonated 9-octadecenoic acid (CAS Reg. No. 68988-76-1), sulfonated tall oil fatty acid (CAS Reg. No. 68309-27-3) and mixtures thereof.

Optional Adjuncts

Optional adjuncts that may be employed in compositions of the present invention include dyes, essential oils, buffers, builders, preservatives, cleaning agents, thickeners, and mixtures thereof. Any optional adjunct is selected such that its use does not result in any significant interference, i.e. lessening of the synergistic antimicrobial properties, with the ternary compositions of the present invention.

Generally, the level of any optional adjunct employed is selected based on the requirements for the particular application in hand, and may comprises up to about 10.0 wt % of the aqueous compositions of the present invention.

When employed for compositions and methods thereof for treating surfaces that may come into contact with humans, animals and/or children, the optional adjuncts are preferably selected from materials that have low toxicity or are non-toxic, and/or substances generally recognized as safe, and/or substances allowed as food additives or allowed to come into contact with food or food packaging materials.

In one embodiment of the present invention, compositions and articles employing the compositions comprise optional adjuncts that are selected from those materials and substances designated as Generally Recognized As Safe (“GRAS”) by the United States Environmental Protection Agency (U.S.E.P.A.), the U.S. Food and Drug Administration (FDA), which further includes all materials listed on “Everything” Added to Food in the United States (“EAFUS”): A Food Additive Database, an informational database maintained by the U.S. FDA Center for Food. Safety and Applied Nutrition (CFSAN) under the federal Priority-based Assessment of Food Additives (PAFA) program, administered by the U.S. Department of Health and Human Services, which is hereby incorporated by reference.

In a further embodiment of the present invention, the essential ternary components are selected from those materials designated as GRAS, and/or approved for food use by the FDA, and/or present on the EAFUS list of materials. In yet a further embodiment of the present invention, all components of the inventive composition including all optional adjuncts are selected from those materials designated as GRAS, and/or approved for food use by the FDA, and/or present on the EAFUS list of materials.

Substances Generally Recognized as Safe

Compositions according to the invention may comprise substances generally recognized as safe (GRAS), including essential oils, oleoresins (solvent-free) and natural extractives (including distillates), and synthetic flavoring materials and adjuvants. Compositions may also comprise GRAS materials commonly found in cotton, cotton textiles, paper and paperboard stock dry food packaging materials (referred herein as substrates) that have been found to migrate to dry food and, by inference may migrate into the inventive compositions when these packaging materials are used as substrates for the inventive compositions.

Suitable GRAS materials are listed in the Code of Federal Regulations (CFR) Title 21 of the U.S. FDA Department of Health and Human Services, Parts 180.20, 180.40 and 180.50, which are hereby incorporated by reference. These suitable GRAS materials include essential oils, oleoresins (solvent-free), and natural extractives (including distillates). The GRAS materials may be present in the compositions in amounts of up to about 10 wt %, or alternatively in amounts of from 0.001 to 5 wt %.

Suitable GRAS materials include oils and oleoresins (solvent-free) and natural extractives (including distillates) derived from alfalfa, allspice, almond bitter (free from prussic acid), ambergris, ambrette seed, angelica, angostura (cusparia bark), anise, apricot kernel (persic oil), asafetida, balm (lemon balm), balsam (of Peru), basil, bay leave, bay (myrcia oil), bergamot (bergamot orange), bois de rose (Aniba rosaeodora Ducke), cacao, chamomile (chamomile) flowers, cananga, capsicum, caraway, cardamom seed (cardamom), carob bean, carrot, cascarilla bark, cassia bark, Castoreum, celery seed, cheery (wild bark), chervil, cinnamon bark, Civet (zibeth, zibet, zibetum), ceylon (Cinnamomum zeylanicum Nees), cinnamon (bark and leaf), citronella, citrus peels, clary (clary sage), clover, coca (decocainized), coffee, cognac oil (white and green), cola nut (kola nut), coriander, cumin (cumin), Curacao orange peel, cusparia bark, dandelion, dog grass (quack grass, triticum), elder flowers, estragole (esdragol, esdragon, estragon, tarragon), fennel (sweet), fenugreek, galanga (galangal), geranium, ginger, grapefruit, guava, hickory bark, horehound (hoarhound), hops, horsemint, hyssop, immortelle (Helichrysum augustifolium DC), jasmine, juniper (berries), laurel berry and leaf, lavender, lemon, lemon grass, lemon peel, lime, linden flowers, locust bean, lupulin, mace, mandarin (Citrus reticulata Blanco), marjoram, mate, menthol (including menthyl acetate), molasses (extract), musk (Tonquin musk), mustard, naringin, neroli (bigarade), nutmeg, onion, orange (bitter, flowers, leaf, flowers, peel), origanum, palmarosa, paprika, parsley, peach kernel (persic oil, pepper (black, white), peanut (stearine), peppermint, Peruvian balsam, petitgrain lemon, petitgrain mandarin (or tangerine), pimenta, pimenta leaf, pipsissewa leaves, pomegranate, prickly ash bark, quince seed, rose (absolute, attar, buds, flowers, fruit, hip, leaf), rose geranium, rosemary, saffron, sage, St. John's bread, savory, schinus molle (Schinus molle L), sloe berries, spearmint, spike lavender, tamarind, tangerine, tarragon, tea (Thea sinensis L.), thyme, tuberose, turmeric, vanilla, violet (flowers, leaves), wild cherry bark, ylang-ylang and zedoary bark.

Suitable synthetic flavoring substances and adjuvants are listed in the Code of Federal Regulations (CFR) Title 21 of the United States Food and Drug Administration, Department of Health and Human Services, Part 180.60, which is hereby incorporated by reference.

Suitable synthetic flavoring substances and adjuvants that are generally recognized as safe for their intended use, include acetaldehyde (ethanal), acetoin (acetyl methylcarbinol), anethole (parapropenyl anisole), benzaldehyde (benzoic aldehyde), n-Butyric acid (butanoic acid), d- or 1-carvone (carvol), cinnamaldehyde (cinnamic aldehyde), citral (2,6-dimethyloctadien-2,6-al-8, geranial, neral), decanal (N-decylaldehyde, capraldehyde, capric aldehyde, caprinaldehyde, aldehyde C-10), ethyl acetate, ethyl butyrate, 3-Methyl-3-phenyl glycidic acid ethyl ester (ethyl-methyl-phenyl-glycidate, so-called strawberry aldehyde, C-16 aldehyde), ethyl vanillin, geraniol (3,7-dimethyl-2,6 and 3,6-octadien-1-ol), geranyl acetate (geraniol acetate), limonene (d-, l-, and dl-), linalool (linalol, 3,7-dimethyl-1,6-octadien-3-ol), linalyl acetate (bergamol), methyl anthranilate (methyl-2-aminobenzoate), piperonal (3,4-methylenedioxy-benzaldehyde, heliotropin) and vanillin.

Suitable GRAS substances that may be present in the inventive compositions that have been identified as possibly migrating to food from cotton, cotton textiles, paper and paperboard materials used in dry food packaging materials are listed in the Code of Federal Regulations (CFR) Title 21 of the United States Food and Drug Administration, Department of Health and Human Services, Parts 180.70 and 180.90, which are hereby incorporated by reference. The GRAS materials may be present in the compositions either by addition or incidentally owing to migration from the substrates to the compositions employed in the invention, or present owing to both mechanisms.

Suitable GRAS materials that are suitable for use in the invention, identified as originating from either cotton or cotton textile materials used as substrates in the invention, include beef tallow, carboxymethylcellulose, coconut oil (refined), cornstarch, gelatin, lard, lard oil, oleic acid, peanut oil, potato starch, sodium acetate, sodium chloride, sodium silicate, sodium tripolyphosphate, soybean oil (hydrogenated), talc, tallow (hydrogenated), tallow flakes, tapioca starch, tetrasodium pyrophosphate, wheat starch and zinc chloride.

Suitable GRAS materials that are suitable for use in the invention, identified as originating from either paper or paperboard stock materials used as substrates in the invention, include alum (double sulfate of aluminum and ammonium potassium, or sodium), aluminum hydroxide, aluminum oleate, aluminum palmitate, casein, cellulose acetate, cornstarch, diatomaceous earth filler, ethyl cellulose, ethyl vanillin, glycerin, oleic acid, potassium sorbate, silicon dioxides, sodium aluminate, sodium chloride, sodium hexametaphosphate, sodium hydrosulfite, sodium phosphoaluminate, sodium silicate, sodium sorbate, sodium tripolyphosphate, sorbitol, soy protein (isolated), starch (acid modified, pregelatinized and unmodified), talc, vanillin, zinc hydrosulfite and zinc sulfate.

Suitable GRAS materials are particularly preferred for compositions according to the present invention intended for use on food contact surfaces, methods for treated food contact surfaces as well as articles employing the inventive compositions for use thereon.

Water

Since the inventive compositions comprise aqueous dilutions, water can be, along with the monohydric water soluble alkanol, a predominant ingredient. The water is generally present at a level of less than 99.9%, more typically at less than about 99% to less than about 98%. The water may be deionized, industrial soft water, or any suitable grade or water. Where the cleaning composition is concentrated, the water may be present in the composition at a concentration of less than about 85 wt %

Method of Use

The inventive compositions described herein may be employed directly in the form of aqueous dilutions for application onto a target surface in the form of a aerosol, mist, spray, foam, liquid, wash, rinse and the like, or in the form of a bath to treat submerged items, articles or surfaces, and/or added to an aqueous system to treat submerged surfaces. Thus, a wide variety of suitable application methods include for example, but are not limited to, pouring, spraying, application with a trigger sprayer, aerosol sprayer or device containing a pressurized propellant and/or condensed gas, spraying onto a surface from a container attached to a hose, wiping onto a surface with a pre-moistened disposable device such as for example, but not limited to, a nonwoven wipe, cloth and/or sponge wetted with the inventive compositions. Suitable application methods include any method in which the inventive compositions are applied directly in either neat form, or concurrent with and/or following dilution of a concentrated composition with a suitable aqueous diluent, such as for example water.

In one representative embodiment, the inventive compositions may be formulated as concentrated ternary mixtures of the three essential ingredients, optionally including a first aqueous diluent, and thereafter diluted further with a second aqueous diluent, for example water, to prepare a ready-to-use solution when needed. Dilute and dispense cartridge and trigger spray systems commercially available in the market, such as that sold by the Canberra Corporation, Toledo, Ohio, under the JAWS “Just Add Water Systems,” tradename, is a particular non-limiting example of a concentrate-in-cartridge and manual dispensing system in which formulations comprising concentrated ternary or diluted ternary systems according to the present invention could be stored and used, respectively.

During use, and in order to sanitize or disinfect the target surface, the inventive compositions are applied to and allowed to contact the surface for a proscribed time to effect microbial reduction or kill. After this contact time, the inventive compositions may be either allowed to remain in place, or may optionally be wiped or removed from the surface by some suitable means. In preferred embodiments, the level of the ternary components employed, owing to the unusually synergistic antimicrobial efficacy, is sufficiently low even when levels of the active components are selected to achieve full disinfectancy at short contact times, that no removal is necessary owing to the observation that such typical levels required are not observed to leave a visually discernable residue when allowed to dry after treatment of even particularly shiny surfaces on which residues are generally most noticeable by eye.

Optionally, though not required, the treated surface can be rinsed with water to remove the inventive compositions following treatment.

Suitable application means include both manual and automated delivery means for applying the components of the inventive compositions to a surface to render a sanitized and/or disinfected article. Compositions of the invention may optionally include cleaning agents and other adjuncts and hence provide simultaneous cleaning and antimicrobial treatment of surfaces. In one embodiment, the inventive compositions are applied to a soiled surface, for example by means of a spray device or premoistened wipe, whereby soil and other residues are removed from the surface which is thereby simultaneous cleaned and rendered sanitized or disinfected.

The inventive compositions can be used in any suitable for treating inanimate hard surfaces, as defined hereinabove, found in a household, commercial, restaurant, business and/or outdoor environment. Hard surfaces to which the inventive composition may be applied include, but are not limited to those made from metal, plastic, stone both natural and synthetic, e.g., CORIAN, glass, ceramic, painted surfaces, wallpaper, and the like. These surfaces are commonly found among household articles and fixtures including, for example, a sink, tile, bathtub, shower wall, toilet bowl, kitchen countertop, tabletop, table covering, cutting board, eating utensil, stove top, oven, microwave oven, refrigerator, wall, floor, and/or window. In addition, the compositions can be used on the interior and exterior surfaces of hard surfaces found on common objects of construction, including, but not limited to exterior and interior surfaces of an airplane, automobile, bathtub, boat, building, fluid distributing system, household-appliance, household fixture, shower stall, sink, ship, sanitary closet, vehicle, water distribution system, water recirculation system, and/or combinations thereof, and further including the finished, laminated, coated and/or painted surfaces thereof.

In a particular embodiment, the inventive compositions are used as a floor treatment composition in an automated or robotic cleaning device, for example, but not limited to the Scooba Robotic Floor Washer, commercially available from iRobot Corp., Burlington, Mass., which is designed for hard floors made of materials such as tile, linoleum and/or wood, and functions by first vacuuming up loose particles and then applying the cleaning composition to soak up dirt and disinfect the treated surface.

Absorbent Materials

The compositions of the present invention can be used independently from or in conjunction with an absorbent and/or adsorbent material to form a premoistened article suitable for direct usage on a target surface to effect cleaning and disinfecting treatment. For instance, in example embodiments the inventive compositions can be formulated to be used in conjunction with a cleaning wipe, sponge (cellulose, synthetic, etc.), paper towel, napkin, cloth, towel, rag, mop head, squeegee, a robotic device with cleaning pad, and/or other cleaning device that includes an absorbent and/or adsorbent material in the form of a premoistened article. In another embodiment, the inventive compositions can be applied to an absorbent material at an effective level whereby during use an effective amount of the composition is released onto the surface to be treated.

In one embodiment, a premoistened article in the form of a treatment wipe employing the inventive compositions can be made of nonwoven material such as nonwoven, fibrous sheet materials or meltblown, coform, air-laid, spun bond, wet laid, bonded-carded web materials, and/or hydroentangled (also known as spunlaced) materials. The treatment wipe can also be made of woven materials such as cotton fibers, cotton/nylon blends and/or other textiles. The treatment wipe can also include wood pulp, a blend of wood pulp, and/or synthetic fibers, e.g., polyester, rayon, nylon, polypropylene, polyethylene, and/or cellulose polymers. Articles suitable for use include single layer wipes as well as multiple layer constructs, constructs of non-woven articles and sponges, and any suitable combinations that enable at least one surface of a preformed article to be premoistened with the inventive compositions such as to form a premoistened article suitable to treat a surface and release an effective amount of the composition to effect the desired treatment.

The treatment wipe, upon which the improved cleaning composition is loaded thereon to form a premoistened article, is made of an absorbent/adsorbent material. Typically, the cleaning wipe has at least one layer of nonwoven material. The treatment wipe substrate can be composed of suitable unmodified and/or modified naturally occurring fibers including cotton, Esparto grass, bagasse, hemp, flax, silk, wool, wood pulp, chemically modified wood pulp, jute, ethyl cellulose, and/or cellulose acetate. Suitable synthetic fibers can comprise fibers of one, or more, of polyvinyl chloride, polyvinyl fluoride, polytetrafluoroethylene, polyvinylidene chloride, polyacrylics such as ORLON®, polyvinyl acetate, Rayon®, polyethylvinyl acetate, non-soluble or soluble polyvinyl alcohol, polyolefins such as polyethylene (e.g., PULPEX®) and polypropylene, polyamides such as nylon, polyesters such as DACRON® or KODEL®, polyurethanes, polystyrenes, and the like, including fibers comprising polymers containing more than one monomer. The wipe substrate can comprise solely naturally occurring fibers, solely synthetic fibers, or any compatible combination of naturally occurring and synthetic fibers. Nonlimiting examples of commercially available treatment wipes that can be used include DuPont 8838, Dexter ZA, Dexter 10180, Dexter M10201, Dexter 8589, Ft. James 836, and Concert STD60LN, and Ahlstrom 4759. All of these example treatment wipes include a blend of polyester and wood pulp. Dexter M10201 also includes rayon, a wood pulp derivative.

The loading ratio of the inventive compositions onto the treatment wipe is generally about 2-5:1, and typically about 3-4:1, these being expressed in terms of grams of liquid formulation per grams of dry absorbent material. Generally, a loading ratio of at least 1:1 is employed to have an effective level of the inventive composition present for sufficient release and treatment of the composition onto the target surface to effect the desired level of cleaning and disinfection.

The inventive composition is loaded onto the treatment wipe in any number of manufacturing methods. Typically, the treatment wipe is soaked in the inventive composition for a period of time until the desired amount of loading is achieved. Alternatively, a premoistened article may be prepared by spraying or dripping the inventive compositions onto the treatment wipe either individually or pluraly, and either before or after the wipe or plurality of wipes in either in a roll or stacked configuration is packaged within a container, but prior to sealing of the container.

In one embodiment, the absorbent material can be constructed as part of a single or multiple layer cleaning pad attached in either the wet or dry state to the end of a mop. The cleaning pads will preferably have an absorbent capacity, when measured under a confining pressure of 0.09 p.s.i. (pounds per square inch) after 20 minutes, of at least about 1 gram deionized water per gram of the cleaning pad, preferably at least about 10 gram deionized water per g of the cleaning pad.

In another embodiment of the present invention, a ready-to-use premoistened wipe loaded with an effective level of the inventive compositions suitably diluted into an aqueous solution is provided. In an alternative embodiment, a premoistened absorbent article loaded with a precursor composition comprising only the three ternary components of the present invention is provided, combined with a method whereby the step of wetting the article with water as the aqueous diluent in order to form a ready-to-use composition in situ on the article is employed.

Test Methods

Formulas tested and described herein, including controls and commercial samples, as well as the inventive compositions, were evaluated for their antimicrobial efficacy using several test methods, and compared to both control formulations including non-inventive compositions employing combinations of only two of the three essential components of the inventive compositions, and a commercially available antimicrobial product, Clorox Disinfecting Wipes, available from the Clorox Company, Oakland, Calif. Antimicrobial efficacy testing was performed to identify compositions that exhibited synergistically enhanced antimicrobial activity resulting in complete kill of microorganisms (disinfectancy). Antimicrobial efficacy testing was conducted using a simplified and slightly altered version of AOAC Official Method 961.02, referenced hereinbelow, wherein test solutions, or “squeezate” solutions (the extracted liquid from a premoistened wiping article) were placed into contact with an inoculum of dried but viable test organisms (Salmonella choleraesuis ATCC No. 10708, Staphylococcus aureus ATCC No. 6538) in the wells of a microtiter plate at 37° C. (approximately 10⁷ microorganisms per test well). Test solutions were pipetted into each well of the microtiter plate and allowed to contact the organisms for a predetermined contact time, ranging from about 30 seconds to 5 minutes, coincident with continued room temperature incubation. The test solution was then neutralized by addition of excess growth media diluent to prevent any further biocidal activity and enable regrowth of any viable organisms remaining. Following a regrowth period under incubation (approximately 48 hours at 37° C.) the microtiter plate was photographed and the level of turbidity in each individual well was determined. Sixteen test wells were used for each sample as replicates to validate results. One microtiter plate contained both the test sample under evaluation in addition to both positive (a commercial disinfectant) and negative (an untreated test well) controls, and enabled highly consistent and reproducible antimicrobial rankings to be assigned. For each test sample, a ranking of “+” was assigned to indicate equivalent disinfection (no observed turbidity, no growth), while “−” was assigned to indicate lack of disinfection (any degree of turbidity indicating some growth) versus results observed from using the positive control sample, a commercial disinfectant product. Compositions tested and assigned a positive ranking indicative of antimicrobial activity are capable of at least sanitization efficacy, equivalent to at least a 10³ (3-log) reduction in the population of the tested microorganisms. Test results thus obtained were found to reliably correlate with results obtained using the AOAC test method, which is used herein to test efficacy with respect to disinfecting levels of microbial reduction.

A second test method was also employed to determine germicidal efficacy. Test formulations were subjected to the “AOAC Official Method 961.02 Germicidal Spray Products as Disinfectants” test method published by AOAC International (Copyright 2000), and described in JAOAC 44, 422 (1961); JAOAC 50, 763 (1967); Soap Chem. Spec. 38(2), 69 (1962); and Soap Chem. Spec. 61, 400 (1978), all of which are hereby incorporated by reference. This germicidal spray test (GST) method is suitable for determining effectiveness of sprays and pressurized spray products as spot disinfectants for contaminated surfaces. This method was also employed to test the germicidal efficacy of test formulations present on a premoistened wiping article (Towlette) by first collecting “squeezate” solutions which were then tested accordingly. In both procedures, disinfectancy test results are generally reported as the number of tubes (“carriers”) exhibiting any regrowth of microorganisms, if any, after incubation of a culture of the selected microorganism previously treated with the test composition under selected conditions, and transferred to a test tube with nutrient and subsequently incubated to determine if any viable organisms remain. If even one carrier exhibits any degree of regrowth, this is an indication that less than 100% kill (disinfectancy) was achieved by the test composition under the selected conditions. Typically, the absence of any discernable growth after incubation indicates that at least greater than a 10⁶ fold (6-log) reduction in the population of any remaining viable microorganism following treatment has occurred. Generally, a large number of replicates (30 to 60) are performed for liquid formulations, and a smaller number of replicates for materials in the form of premoistened wipes, wherein testing of the wetting formulation in the form of isolated squeezate (lotion) solution are performed. This latter testing enables confirmation that the inventive compositions, when applied and subsequently released from an absorbent carrier, such as would occur during use in methods according to the present invention for treating a surface, provide the synergistic antimicrobial activity observed in the neat formulations, thus confirming that the absorbent substrate does not interfere with nor act to counter the observed synergistic antimicrobial effects described herein.

Test results confirmed the unexpected discovery of a compositional phase region comprising mixtures of the three essential components of the present invention in which surprising synergistic antimicrobial performance against both Staphylococcus aureus and Salmonella choleraesuis are observed, and particularly compositions effective at relatively low total active levels providing for compositions capable of cleaning and either sanitizing and/or disinfecting of hard surfaces. Inventive compositions with relatively low total actives are particularly suited for cleaning and disinfection of surfaces in that they tend to leave no significant visible residue even when left in place following treatment without a subsequent rinsing step, which is particularly preferred when longer contact times (>30 seconds) are required to achieve the required level of sanitization or complete disinfectancy according to the desired application. Compositions lacking any of the three essential components were observed to fail to exhibit the surprising antimicrobial efficacy observed with inventive compositions having the three components present within the synergistic phase region shown in FIG. 1, where the boundaries of the region is indicated by the four indicated extrema, corresponding to compositions wherein the Ternary Ratio of (i) alpha-hydroxycarboxylic acid, (ii) monohydric water soluble alkanol, and (iii) anionic tenside, is found to be 0.37:0.58:0.05, 0.05:0.58:0.37, 0.61:0.34:0.05 and 0.05:0.34:0.61, respectively.

The following examples are meant to exemplify compositions, methods and articles employing the compositions to demonstrate their usefulness, utility and some advantages enabled by selected embodiments of the inventive compositions, but are not intended to limit or otherwise define the scope of the present invention.

### EXAMPLES

### Chemical Key

Dowanol PM=propylene glycol monomethyl ether from Dow Chemical, Midland, Mich.
Dowanol DPM=dipropylene glycol monomethyl ether from Dow Chemical
Dowanol PnB=propylene glycol mono-n-butyl ether from Dow Chemical
Dowfax 2A1=dodecyl diphenyloxide disulfonate, (CAS Reg. No. 30260-73-2), commercially available from Dow Chemical
C12DADS=disodium N-decyldiphenyl ether disulfonate (CAS Reg. No. 36445-71-3)
LSS=lignin sodium sulfonate (CAS Reg. No. 008061-51-6)
SOS2=1-octanesulfonic-2-sulfinic acid (CAS Reg. No. 113652-56-5)
ODS=1,2-octanedisulfonic acid (CAS Reg. No. 113669-58-2)
SOS=sodium 1-octanesulfonate (CAS Reg. No. 5324-84-5)
SES=sodium 2-ethylhexyl sulfate (CAS Reg. No. 000126-92-1)
BOS=butyl oleate sulfate (CAS Reg. No. 038621-44-2)
SODC=sulfonated 9-octadecenoic acid (CAS Reg. No. 68988-76-1)
STOFA=sulfonated tall oil fatty acid (CAS Reg. No. 68309-27-3)
Ethanol=Food grade, U.S.P. or denatured grain alcohol (CAS Reg. No. 64175)
IPA=isopropanol (CAS Reg. No. 67-63-0)
APG=APG 325N, alkylpolyglycoside nonionic surfactant, available from Cognis Corporation, Cincinnati, Ohio
SLS=sodium lauryl sulfate (CAS Reg. No. 000151-21-3)
SNS=sodium n-alkyl benzene sulfonate (CAS Reg. No. 008046-53-5)
SDS=sodium decylbenzene sulfonate (CAS Reg. No. 001322-98-1)
SDDS=sodium dodecylbenzene sulfonate (CAS Reg. No. 025155-30-0)
SFA=sucrose fatty acid esters (CAS Reg. No. 977019-37-6)
Nyacol 203PI=acidic nanoparticle-sized silica, available from Akzo Nobel.
Tween 20=polyoxyethylene (20) sorbitan monolaurate, available from Uniquema Co.
SC=Sucrose cocoate nonionic ester, sold as Crodesta SL-40, available from Croda, Inc.
Polysorbate 80=polyoxyethylene (20) sorbitan monooleate, sold as Crillet 4NF by Croda, Inc.
Tea Tree Oil=Lemon scented essential oil extract, from Down Under Enterprises.

### Example 1

Examples of compositions tested to demonstrate the utility of various embodiments of the present invention, including appropriate control and commercial compositions for comparison are presented in Example 1. Table 1A shows inventive compositions, expressed in terms of the Ternary Ratio of the three essential components in combinations in which the Ternary Ratio is within the synergistic ternary phase region described hereinabove, and as presented in FIG. 1.

Inventive compositions are found to provide synergistic antimicrobial activity against both gram positive and gram negative bacteria, (Salmonella choleraesuis ATCC No. 10708, Staphylococcus aureus ATCC No. 6538), using the antimicrobial test methods described above, with contact times of 10 minutes at 25° C., without rinsing. Inventive compositions 1A through 1E demonstrate synergistic combinations having effective biocidal efficacy against both bacteria. Example embodiment compositions 1F and 1G represent formulations, otherwise identical to Example 1E, further comprising optional adjuncts, including a partially water soluble glycol ether and a tea tree oil fragrance additive, that demonstrate that inventive compositions continue to demonstrate antimicrobial efficacy with additional adjuncts present.

Inventive compositions even with relatively low levels of the alpha-hydroxycarboxylic acid are found to be antimicrobially effective when in combination with the a water soluble monohydric alkanol and anionic tenside within the synergistic ternary phase region. While alpha-hydroxycarboxylic acids are known to exhibit antimicrobial properties at higher levels in combination with long contact times, results of tests for comparison compositions having only the alpha-hydroxycarboxylic organic acid component, in this example lactic acid, are found to fail the antimicrobial efficacy test, as shown in Table 1B for comparative Examples C and D.

TABLE 1A

| | Composition | | | | | | | |
|---|---|---|---|---|---|---|---|---|
| | 1A | 1B | 1C | 1D | 1E | 1F | 1G | 1H |
| Ingredient: | | | | | | | | |
| Lactic Acid | 1.07 | 2.98 | 1.08 | 3.37 | 3.0 | 3.0 | 3.0 | 3.0 |
| Ethanol | 2.95 | 2.87 | 3.08 | 3.13 | 3.0 | 3.0 | 3.0 | 3.0 |
| Dowanol PnB | | | | | | 1.0 | 1.0 | |
| Dowfax 2A1 | 2.0 | 1.91 | | | 1.0 | 1.0 | 1.0 | 0.6 |
| SLS | | | 2.18 | 2.14 | | | | |
| Tea Tree Oil | | | | | | | 0.125 | |
| Water (to 100%) | q.s. | q.s. | q.s. | q.s. | q.s. | q.s. | q.s. | q.s. |
| Parameters: | | | | | | | | |
| pH | 2.5 | 2.2 | 2.6 | 2.3 | 2.1 | 2.1 | 2.1 | 2.2 |
| Ternary Ratio | 0.18: | 0.38: | 0.17: | 0.39: | 0.43: | 0.43: | 0.45: | 0.09: |
| | 0.49: | 0.37: | 0.49: | 0.36: | 0.43: | 0.43: | 0.45: | 0.455: |
| | 0.33 | 0.25 | 0.34 | 0.25 | 0.14 | 0.14 | 0.10 | 0.455 |
| Antimicrobial | | | | | | | | |
| Ranking: | | | | | | | | |
| Staphylococcus | + | + | + | + | + | + | + | + |
| aureus | | | | | | | | |
| Salmonella | + | + | + | + | + | + | + | + |
| choleraesuis | | | | | | | | |

When other combinations of only two of the three ternary components of the present invention are tested, results demonstrate a lack of antimicrobial efficacy. Comparative Examples E, F and G, lacking the alpha-hydroxycarboxylic acid component, but having otherwise comparable levels of both monohydric alkanol and the anionic tenside components fail to demonstrate effective antimicrobial efficacy. A commercial disinfectant product, Clorox Disinfecting Wipes™, available from the Clorox Company, Oakland, Calif., was tested as a comparative control.

Even when comparative compositions having the three components present are formulated at similar levels and solution pH, however having a Ternary Ratio that is outside of the synergistic region as described herein, the comparative compositions fail to demonstrate effective antimicrobial efficacy. For example, comparative formulations A and B, each having a Ternary Ratio outside of the ternary phase region according to the present discovery, all fail to demonstrate antimicrobial efficacy.

TABLE 1B

| | Composition | | | | | | | |
|---|---|---|---|---|---|---|---|---|
| | A | B | C | D | E | F | G | H(1) |
| Ingredient: | | | | | | | | |
| Lactic Acid | 1.07 | 1.04 | 1.10 | 3.42 | | | | |
| Ethanol | 2.98 | 2.91 | | | 2.96 | 3.0 | 3.0 | |
| Dowanol PnB | | | | | | | 2.0 | |
| Dowfax 2A1 | 0.50 | 0.92 | | | | 2.0 | | |
| SLS | | | | | 2.04 | | | |
| Water | q.s. | q.s. | q.s. | q.s. | q.s. | q.s. | q.s. | |
| (to 100%) | | | | | | | | |
| Parameters: | | | | | | | | |
| pH | 2.4 | 2.4 | 2.3 | 2.1 | 5.2 | 7.8 | 5.6 | |
| Ternary Ratio | 0.24: | 0.21: | 1:0:0 | 1:0:0 | 0:1:0 | 0: | 0: | |
| | 0.65: | 0.60: | | | | 0.6: | 0.6: | |
| | 0.11 | 0.19 | | | | 0.4 | 0.4 | |
| Antimicrobial | | | | | | | | |
| Ranking: | | | | | | | | |
| Staphylococcus | − | − | − | − | − | − | − | + |
| aureus | | | | | | | | |
| Salmonella | − | − | − | − | − | − | − | + |
| choleraesuis | | | | | | | | |

(1)Clorox Disinfecting Wipes, available from the Clorox Company, Oakland, CA. Contains a cationic quaternary ammonium biocidal active registered with EPA.

Results of example embodiments tested according to AOAC Official Method 961.02 are presented in Table 1C, which includes results of formulations tested in neat form as a spray (GST procedure), and in the form of a premoistened wiping article (Towelette procedure). Formulations in the form of spray embodiments of the present invention provided full disinfectancy (>6-log reduction) within a 10 minute contact time against Staphylococcus aureus, with no carriers of 30 replicates exhibiting any residual microbial activity, even in the presence of a high (5%) soil load. Several example embodiments were also tested in with and without soil load, and the squeezate (lotion) also evaluated. Premoistened wipes loaded at level of 3.75 g/g substrate with example composition embodiments 1B and 1H, using an Ahlstrom 12176 sheet (mixed wood pulp with bicomponent rayon and polyethylene terephthalate fibers) were found to provide full disinfectancy when used as a wiping article, with no carriers of 60 replicates exhibiting any residual microbial activity, with or without high (5%) soil load present. In addition, the lotion was also tested in duplicate towlette examples (premoistened wipes stored overnight in plastic bags) with results indicating that extracted liquid continued to provide full disinfectancy as well, with no carriers of 6 replicates exhibiting any residual microbial activity.

These results confirm that the ternary compositions according to the present invention can exhibit either sanitization and/or disinfectancy when used in the form of a spray or premoistened towlette on microbially contaminated surfaces.

TABLE 1C

| Compo- | | | | Soil | Contact | |
|---|---|---|---|---|---|---|
| sition | Form | Organism | Method | Load | Time | Results |
| 1B | Spray | Staphylococcus | Spray | 5% | 10 min | 0/30 |
| | | aureus | (GST) | | | carriers |
| 1D | Spray | Staphylococcus | Spray | 5% | 10 min | 0/30 |
| | | aureus | (GST) | | | carriers |
| 1B (1) | Wipe | Staphylococcus | Towelette | None | 9 min 55 | 0/60 |
| | | aureus | | | sec | carriers |
| | | | | | | 0/6 |
| | | | | | | lotion |
| 1B (1) | Wipe | Staphylococcus | Towelette | 5% | 9 min 55 | 0/60 |
| | | aureus | | | sec | carriers |
| | | | | | | 0/6 |
| | | | | | | lotion |
| 1H (1) | Wipe | Staphylococcus | Towelette | 5% | 9 min 55 | 0/60 |
| | | aureus | | | sec | carriers |
| | | | | | | 0/6 |
| | | | | | | lotion |
| 1B (1) | Wipe | Staphylococcus | Towelette | 5% | 9 min 55 | 0/60 |
| | | aureus | | | sec | carriers |
| | | | | | | 0/6 |
| | | | | | | lotion |

(1) Premoistened wipes composition loaded at level of 3.75 g/g substrate, using an Ahlstrom 12176, commercially available from Ahlstrom Corp., Windsor Locks, CT.

### Example 2

### Food Contact Sanitizer

Example 2 formulations presented in Table 2 demonstrate embodiments of sanitizing spray cleaner composition suitable for use on food contact surfaces in a kitchen including counter tops, stove tops, food preparation areas, table tops, and trays.

TABLE 2

| | Composition | | | | | | | |
|---|---|---|---|---|---|---|---|---|
| Ingredient: | 2A | 2B | 2C | 2D | 2E | 2F | 2G | 2H |
| Lactic Acid | 1.07 | 1.08 | 3.0 | 3.37 | | | | |
| Citric Acid | | | | | 3.0 | | | |
| Glycolic Acid | | | | | | 3.0 | | |
| Mandelic Acid | | | | | | | 3.0 | |
| Malic Acid | | | | | | | | 3.0 |
| Ethanol (1) | 3.0 | 3.10 | 2.87 | 3.13 | 3.0 | 3.0 | 3.0 | 3.0 |
| Dowfax 2A1 | 2.0 | | 1.91 | | | | | |
| SLS | | 1.15 | | 2.14 | | | | |
| C12DADS | | | | | 2.0 | | | |
| SDDS | | | | | | 2.0 | | |
| SES | | | | | | | 2.0 | |
| SDS | | | | | | | | 2.0 |
| Polysorbate | | | | | | | | 0.5 |
| 80 | | | | | | | | |
| Water (to | q.s. | q.s. | q.s. | q.s. | q.s. | q.s. | q.s. | q.s. |
| 100%) | | | | | | | | |

(1) Food grade ethyl alcohol without denaturant

### Example 3

### Hard Surface Disinfectant

Compositions representing embodiments of the present invention suitable for use as general purpose hard surface disinfectants for the variety of surfaces found around a home and institutional environment including floors, walls, vinyl and tiled surfaces are presented in Table 3. Example 3G is representative of one embodiment of the present invention utilizing a mixed water soluble solvent system for heavy duty cleaning and disinfection on soiled bathroom surfaces that is tolerate of dilution during use, and suitable therefore when used on previously wetted surfaces such as for example, a wet shower, toilet bowl interior or bathtub surface.

TABLE 3

| | Composition | | | | | | | |
|---|---|---|---|---|---|---|---|---|
| Ingredient: | 3A | 3B | 3C | 3D | 3E | 3F | 3G | 3H |
| Lactic Acid | 3.0 | 3.0 | 3.0 | 3.37 | | | | |
| Citric Acid | | | | | 4.0 | | | |
| Glycolic Acid | | | | | | 4.0 | | |
| Mandelic Acid | | | | | | | 7.5 | |
| Malic Acid | | | | | | | | 3.0 |
| Ethanol | 3.0 | 3.0 | 3.0 | | | | | |
| Isopropanol | | | | 3.0 | 6.0 | | 4.0 | |
| Dowanol PM | | | | | | 6.0 | 3.5 | 2.5 |
| Dowanol PnB | | | 1.0 | | | | | |
| Dowfax 2A1 | 2.0 | 1.0 | 1.0 | 2.0 | | 1.0 | 1.75 | |
| SLS | | | | | 6.0 | 5.0 | 2.0 | |
| SDS | | | | | | | | 1.0 |
| APG | | | | | | | 0.5 | |
| Tea Tree Oil | | 0.125 | 0.125 | | | 0.125 | 0.125 | 0.05 |

### Example 4

### Bathroom Cleaner

Compositions representing embodiments of the present invention suitable for use as general purpose cleaners with sanitizing or disinfecting action for a variety of bathroom surfaces and materials including tile, PVC shower walls, porcelain, enamel, metal and glass surfaces are presented in Table 4. Example 4E is representative of one embodiment of the present invention wherein the beneficial antimicrobial properties of the inventive synergistic ternary systems are not negatively effected by addition of a functional adjunct, here a nano-size silica particle dispersion to provide additional antifogging properties to treated surfaces. Example 4I is representative of one embodiment of the present invention utilizing a mixed water soluble solvent system intended as a dilutable cleaner for heavy duty cleaning and disinfection on soiled bathroom surfaces, particularly surfaces with oily residues such as a shower stall, bathtub, or floor.

TABLE 4

| | Composition | | | | | | | | |
|---|---|---|---|---|---|---|---|---|---|
| Ingredient: | 4A | 4B | 4C | 4D | 4E | 4F | 4G | 4H | 4I |
| Lactic Acid | 3.0 | 3.0 | 3.0 | 3.0 | 3.37 | | | | |
| Citric Acid | | | | | | 1.0 | | | |
| Glycolic Acid | | | | | | | 1.0 | | |
| Mandelic Acid | | | | | | | | 3.0 | |
| Malic Acid | | | | | | | | | 7.0 |
| Ethanol | 3.0 | 3.0 | 3.0 | 3.0 | | | | | |
| Isopropanol | | | | | 3.0 | 1.8 | | | 7.0 |
| Dowanol DPM | | | | | | | 1.8 | 2.5 | 7.0 |
| Dowanol PnB | | | 1.0 | | | | | | |
| Dowfax 2A1 | 2.0 | 1.0 | 1.0 | 0.6 | 2.0 | | 0.2 | | 1.0 |
| SLS | | | | | | 0.42 | 0.2 | 0.95 | |
| SDS | | | | | | | | | 2.8 |
| APG | | | | | | | | 0.5 | 0.5 |
| Nyacol | | | | 1.0 | | | | | |
| Tea Tree Oil | | 0.125 | 0.125 | | | | | | |
| Fragrance | | | | | | | | 0.05 | 0.05 |
| Water (to 100%) | q.s. | q.s. | q.s. | q.s. | q.s. | q.s. | q.s. | q.s. | q.s. |

### Example 5

### Light Duty Floor Cleaner

Compositions representing embodiments of the present invention suitable for use as light duty floor cleaner and sanitizers for a variety of bathroom surfaces and materials including tile, PVC shower walls, porcelain, enamel, metal and glass surfaces are presented in Table 5.

TABLE 5

Composition

| Ingredient: | 5A | 5B | 5C | 5D |
|---|---|---|---|---|
| Lactic Acid | 3.0 | 1.0 | | |
| Citric Acid | | | 2.0 | |
| Glycolic Acid | | | | 3.0 |
| Ethanol | 3.0 | | 3.0 | |
| Isopropanol | | 1.3 | | 2.5 |
| Dowanol DPM | | 0.5 | | |
| Dowfax 2A1 | 1.0 | 0.42 | 1.0 | 0.5 |
| SLS | | | 2.0 | 0.5 |
| Tea Tree Oil | | | 0.05 | |
| Fragrance | | 0.05 | | 0.05 |
| Water (to 100%) | q.s. | q.s. | q.s. | q.s. |

### Example 6

### Disinfectant Wipe for Kitchen Counter

Example 6 presents premoistened wipe compositions representing embodiments of the present invention suitable for light cleaning and disinfection of kitchen counters and food contact areas. Various absorbent wipe substrates and formulations loaded to provide premoistened articles for kitchen usage are presented in Table 6.

TABLE 6

| Premoistened | | |
|---|---|---|
| Wipe with | | Loading |
| Composition | Substrate | (grams/gram substrate) |
| 2A | Ahlstrom 4759(1) | 2.5 |
| 2B | Dexter 10180(2) | 4.0 |
| 2C | Ahlstrom 4759 | 4.0 |
| 2D | Dexter 10180 | 2.5 |

(1)Commercially available from Ahlstrom Corp., Windsor Locks, CT.
(2)Commercially available from Ahlstrom Corp., Windsor Locks, CT.

### Example 7

### Dilutable Concentrate

Example 7 presents compositions representing embodiments of the present invention suitable for use as dilutable concentrates, that is formulations to be diluted into water to prepare a treatment solution prior to use for heavy duty cleaning and disinfection purposes. These example formulations would be suitable for a bucket dilutable cleaning concentrate in one embodiment, whereby users can select the degree of dilution appropriate to the cleaning needs, yet still reliably producing a disinfectant solution by diluting within the specified range of dilutions with water indicated in the Table 7. Example formulation 7E shows one embodiment suitable for a dilute and dispense cartridge system wherein the concentrate is diluted to use volume with water in a portable trigger spray bottle at a fixed ratio to obtain a convenient ready-to-use solution.

TABLE 7

| | Composition | | | | |
|---|---|---|---|---|---|
| Ingredient: | 7A | 7B | 7C | 7D | 7E |
| Lactic Acid | 6.0 | | | 6.0 | 30.0 |
| Citric Acid | | 7.5 | | | |
| Glycolic Acid | | | 5.0 | | |
| Ethanol | 6.0 | | | | |
| Isopropanol | | 3.5 | 10.0 | 10.0 | |
| Dowanol PM | | | | | 24.3 |
| Dowanol DPM | | 3.5 | 12.5 | 21.5 | |
| Dowfax 2A1 | 2.0 | 1.25 | 2.50 | 5.0 | 0.5 |
| SLS | | 2.50 | 20.0 | 42.0 | 9.0 |
| Tea Tree Oil | | | 0.25 | 1.0 | |
| Fragrance | 0.05 | 0.05 | | | 0.1 |
| Water (to 100%) | q.s. | q.s. | q.s. | q.s. | q.s |
| Dilution-to-Use | 10:1 | 12:1 | 8:1 | 10:1 | 60:1 |
| Ratio (with water) | to | to | to | to | |
| | 2:1 | 2:1 | 2:1 | 2:1 | |

### Example 8

### Ready-to-Use Robotic Floor Cleaner

Example 8 presents formulations representing embodiments of the present invention suitable for ready-to-use cleaning and disinfecting solutions onboard a robotic floor cleaning device that is capable of applying the solution directly to a floor surface, such as a coated wood, vinyl, linoleum, tile, marble or stone material for light duty cleaning and disinfection. The compositions may be applied by any suitable means, including a spray or aerosol delivery, or via a moistened absorbent article that is contacted with the surface to be treated. Example compositions are presented in Table 8.

TABLE 8

| | Composition | | |
|---|---|---|---|
| Ingredient: | 8A | 8B | 8C |
| Lactic Acid | 1.0 | | |
| Citric Acid | | 0.5 | |
| Glycolic Acid | | | 2.0 |
| Ethanol | 3.0 | | |
| Isopropanol | | 0.9 | |
| Dowanol PM | | | 2.0 |
| Dowfax 2A1 | 1.5 | 0.21 | 0.5 |
| SLS | 0.5 | | 0.5 |
| Fragrance | 0.01 | 0.005 | 0.005 |
| Water (to 100%) | q.s. | q.s. | q.s. |

The foregoing has described the principles, illustrative embodiments, and modes of operation of the present invention. However, the invention should not be construed as limited to the particular embodiments and/or examples discussed herein. Instead, the above described embodiments should be regarded as illustrative rather than restrictive, and it should be appreciated that variations and modifications may be made in those embodiments by workers skilled in the art without departing from the scope of the present invention as defined by the following claims.

We claim:

1. A composition comprising: (A) a ternary mixture comprising: (i) an alpha-hydrdxycarboxylic acid; (ii) a monohydric water soluble alkanol; and (iii) an anionic tenside; wherein said ternary mixture is within a phase region bordered by extrema comprising a Ternary Ratio of (i):(ii):(iii) being 0.37:0.58:0.05, 0.05:0.58:0.37, 0.61:0.34:0.05 and 0.05:0.34:0.61; and (B) an aqueous diluent; wherein said composition has a pH less than 7; and wherein said composition provides at least a 3-log reduction of either Staphylococcus aureus or Salmonella choleraesuis.

2. The composition of claim 1, wherein said composition provides at least a 6-log reduction of both Staphylococcus aureus and Salmonella choleraesuis.

3. The composition of claim 1, wherein without any one of (i), (ii), or (iii), said composition does not provide said at least a 3-log reduction of either Staphylococcus aureus or Salmonella choleraesuis.

4. The composition of claim 1, wherein said composition is free of quaternary ammonium biocides.

5. The composition of claim 1, wherein said alpha-hydroxycarboxylic acid is selected from the group consisting of citric, lactic, glycolic, malic, and mandelic acid.

6. The composition of claim 1, wherein said composition further comprises at least one additional adjunct selected from the group consisting of dyes, essential oils, buffers, builders, preservatives, cleaning agents, thickeners, and mixtures thereof.

7. The composition of claim 6, wherein said composition comprises only GRAS and/or food grade ingredients.

8. The composition of claim 1, wherein said monohydric water soluble alkanol is selected from the group consisting of methanol, ethanol, isopropanol, butanol, pentanol, glycol ether, and mixtures thereof.

9. The composition of claim 8, wherein said monohydric water soluble alkanol is ethanol.

10. The composition of claim 8, wherein said glycol ether is selected from the group consisting of ethylene glycol monopropyl ether, ethylene glycol monobutyl ether, ethylene glycol monohexyl ether, diethylene glycol monopropyl ether, diethylene glycol monobutyl ether, diethylene glycol monohexyl ether, propylene glycol methyl ether, propylene glycol ethyl ether, propylene glycol mono-n-propyl ether, propylene glycol mono-iso-propyl ether, propylene glycol monobutylether, dipropylene glycol monomethylether, and/or combinations thereof.

11. The composition of claim 1, wherein said monohydric water soluble alkanol is present at a level of 1.0 to 5.0 wt %.

12. The composition of claim 1, wherein said alpha-hydroxycarboxylic acid is present at a level of between 0.5 to 5.0 wt % of the total composition.

13. The composition of claim 1, wherein said anionic tenside comprises an anionic wetting agent selected from the group consisting of alkyl phosphates, alkyl phosphonates, alkyl sulfates, alkyl sulfonates, aryl sulfonates, alkyl aryl sulfonates, alkyl disulfonates, alkyldiphenyloxide disulfonate and/or combinations thereof.

14. The composition of claim 13, wherein said anionic surface wetting agent comprises an alkyl sulfate having between 8 to 18 carbon atoms.

15. The composition of claim 13, wherein said anionic surface wetting agent comprises an alkyldiphenyloxide disulfonate with an alkyl group having between 6 to 12 carbon atoms.

16. The composition of claim 1, wherein said anionic tenside is present at a level of 0.1 to 3.0 wt %.

17. A method for disinfecting a hard surface comprising contacting said hard surface by direct application of a composition comprising: (A) a ternary mixture comprising: (i) from about 0.5 to 3.0% of an alpha-hydroxycarboxylic acid; (ii) from about 0.5 to 5.0% of a monohydric water soluble alkanol; and (iii) from 0.1 to 3.0% of an anionic tenside; wherein said ternary mixture is within a phase region bordered by extrema comprising a Ternary Ratio of (i):(ii):(iii) being 0.37:0.58:0.05, 0.05:0.58:0.37, 0.61:0.34:0.05 and 0.05:0.34:0.61; (B) an aqueous diluent; (C) optionally, an adjunct selected from the group consisting of dyes, essential oils, buffers, builders, preservatives, cleaning agents, thickeners, and mixtures thereof; wherein said composition has a pH less than 7; and wherein said composition provides at least a 3-log reduction of either Staphylococcus aureus or Salmonella choleraesuis.

18. The method of claim 17, wherein said hard surface comprises a food contact surface, and wherein said composition comprises only GRAS and/or food grade ingredients.

19. A premoistened article comprising an absorbent substrate impregnated with an effective amount of a composition comprising: (A) a ternary mixture comprising: (i) from about 0.5 to 3.0% of an alpha-hydroxycarboxylic acid; (ii) from about 0.5 to 5.0% of a monohydric water soluble alkanol; and (iii) from 0.1 to 3.0% of an anionic tenside; wherein said ternary mixture is within a phase region bordered by extrema comprising a Ternary Ratio of (i):(ii):(iii) being 0.37:0.58:0.05, 0.05:0.58:0.37, 0.61:0.34:0.05 and 0.05:0.34:0.61; (B) an aqueous diluent; (C) optionally, an adjunct selected from the group consisting of dyes, essential oils, buffers, builders, preservatives, cleaning agents, thickeners, and mixtures thereof; wherein said composition has a pH less than 7; and wherein said effective amount of said composition provides at least a 3-log reduction of either Staphylococcus aureus or Salmonella choleraesuis.

20. The premoistened article of claim 19, wherein said alpha-hydroxycarboxylic acid is selected from the group consisting of citric acid, lactic acid, glycolic acid, mandelic acid, malic acid and combinations thereof.
